(19) United States
(12) Patent Application Publication
(10) Pub. No.: US 2008/0146092 A1
(43) Pub. Date: Jun. 19, 2008

(54) Printed circuit board connection

(76) Inventors: William Fillmore Taylor, Bend, OR (US); Brian John Hoffman, Bend, OR (US); Travis Anthony Bizjak, Bend, OR (US); Alexander Faveluke, Wilsonville, OR (US)

Correspondence Address: Paul T. Parker;PERKINS COIE LLP, P.O. Box 1247, Seattle, WA, 98111-1247, US

(21) Appl. No.: 11/639,524

(22) Filed: Dec. 14, 2006

(51) Int. Cl. H01R 11/11

(52) U.S. Cl. 439/883

(57) ABSTRACT

A technique is disclosed which uses captive fasteners to create secure electrical connections between a printed circuit board (PCB) and an external conductor. The captive fastener provides both a mechanical attachment for an electrical lead and an electrical connection to a circuit on the PCB. The captive fastener may be a captive nut, a captive stud, a standoff, a clip, or another suitable type of captive fastener. The captive fastener may be made of electrically conductive material and it may be in electrical contact with a circuit on the PCB.

### RELATED APPLICATIONS

Co-pending patent application Ser. No. 11/187,059 11/400,720, 11/400,776, 11/400,761, 11/400,775, and 11/400,716 are incorporated herein by reference.

### PRIOR ART APPLICATIONS

Prior art contains various methods of making electrical and mechanical connections on printed circuit boards. Some use multiple pieces that clamp or are otherwise fastened, such as U.S. Pat. No. 5,381,598 to Adachi et al., U.S. Pat. No. 6,379,197 to Matsuda et al., U.S. Pat. No. 6,692,314 to Pares Caselles and Japanese Patent No 04140427 to Natsuo, which are incorporated herein by reference. Other prior art inventions require solder to hold the fastener captive, such as U.S. Pat. No. 4,523,883 to Peterson et al., U.S. Pat. No. 4,570,338 to Ignatowicz, which are incorporated herein by reference.

### FIELD OF THE INVENTION

The invention relates to the design of an electrical connection to a printed circuit board.

### BACKGROUND OF THE INVENTION

Printed circuit boards (PCB) conduct electric signals and electric power between components both on the PCB and through connectors to components off the PCB. Certain applications which make the use of PCBs face the challenge of securely connecting large conductors.

Inverters use sophisticated electronics to efficiently convert DC power to AC power and provide a number of safety and user interface features. Often the circuitry for these inverters makes use of a printed circuit board (PCB) including running significant power through PCBs. In order to handle the amount of power being run through the PCB inverter technology is pushing the bounds of PCB technology by increasing the thickness, number of layers, and width of tracks of conducting material for a single connection. The large amount of power requires connections to wires and bus bars of significant size, for instance a two gauge wire may need to have a secure electrical connection to a PCB. The connection of large conductors to PCBs is a challenge for the inverter industry since typically much smaller conductors (16 gauge and smaller) are connected to a PCB. There are connectors commercially made for connection of large wires or bus bars to a PCB but all face one or more of the following challenges: poor electrical contact, electrical contact degrading over time, excessive torque damaging the PCB or connector when the connectors are tightened, inconvenience of using through hole fasteners, and bulky or awkward profile on the PCB. Another way to secure a larger conductor or wire to a PCB is direct soldering. Unfortunately directly soldering connections after the PCB is installed can be time consuming and messy, further, removing such a connection is also very inconvenient.

Captive fasteners such as those popularized by the PEM brand (examples of which can be found at this website http://www.pemnet.com/fastening_products/ accessed Oct. 31, 2006, (website incorporated herein by reference) are used to provide a fastener integral to a sheet of material, typically sheet metal, eliminating the need for a through-hole fastener. A captive fastener has ridges or other mechanical feature in the region passing through a sheet of material which in combination with a pressure fit secure the captive fastener to the sheet of material.

Captive fasteners are detailed in many patents including, U.S. Pat. No. 6,868,590 to Bentrim, U.S. Pat. No. 6,761,520 to Dise, D U.S. Pat. No. 478,806 to McDonough et al., U.S. Pat. No. 705,221 to Diehl et al., U.S. Pat. No. 6,866,456 to Bentrim, U.S. Pat. No. 6,814,530 to Franco et al., U.S. Pat. No. 6,394,724 to Kelly et al., U.S. patent application Nos. 2006/0196330 to Franco et al., 2006/099047 to Bentrim, 2006/077285 to Maloney, and World Intellectual Property Organization Patent Nos 2004106753, 209634, 2005079249, 306968, 2086334 which are incorporated herein by reference.

A captive nut will allow a bolt to be tightened to the sheet of material, while the bolt is tightened the nut holds fast to the material. Several types of fastener have been developed for this sort of application, notably threaded studs, standoffs, and even clip on fasteners can be made captive in the backing material.

Captive fasteners are used in many applications.

Recently this technology has been used with PCBs to provide mounting to various support structures. The captive fasteners are inserted in a part of the PCB without conductive material and then a mating fastener is used to secure the PCB in place. If a PCB needs to be grounded to its mounting structure a captive fastener may be placed through a PCB at a location where conductive material is present; this conductive material is a part of the PCB grounding system and the ground path goes from the conductive track on the PCB through the captive fastener and to a chassis to which the PCB is mounted. Currently this grounding to chassis through a captive support element is the only way in which Captive fasteners are an electric element of a PCB.

It would be advantageous to provide a high power secure electrical connection which is integral to a PCB.

### SUMMARY OF THE INVENTION

Embodiments of the disclosed invention provide a captive fastener mounted in a PCB through areas containing the conductive material. The captive fastener provides a secure electrical connection between the PCB and an external conductor. Captive fasteners may be made of conductive material such as aluminum, brass, or copper and conduct electricity within the fastener as part of a conduction path. Alternately captive fasteners may be made from poorly conducting material such as steel or stainless steel and simply provide a convenient and strong way to secure electrical leads to conductive pads on a PCB.

### BRIEF DESCRIPTION OF THE DRAWINGS

Features and advantages according to embodiments of the invention will be apparent from the following Detailed Description taken in conjunction with the accompanying drawings, in which:

FIG. 1 shows a plan view of a PCB with an electrical track and captive fasteners according to embodiments of the present invention.

FIG. 2 shows a cross sectional view of a conductor lead, bolts and a PCB with an electrical track and a captive nuts according to embodiments of the present invention.

FIG. 3 shows a close up cross sectional view of a PCB with an electrical track and captive nuts according to embodiments of the present invention.

FIG. 4 shows a cross sectional view of a conductor lead, nuts and a PCB with an electrical track and captive threaded studs according to embodiments of the present invention.

FIG. 5 shows a cross sectional view of a conductor lead, screws and a PCB with an electrical track and captive stand offs according to embodiments of the present invention.

### DETAILED DESCRIPTION OF THE DRAWINGS

An innovative method for making electrical connections to a printed circuit board (PCB) using captive fasteners is herein disclosed. The description of specific embodiments herein is for demonstration purposes and in no way limits the scope of this disclosure to exclude other not specifically described embodiments of the present invention.

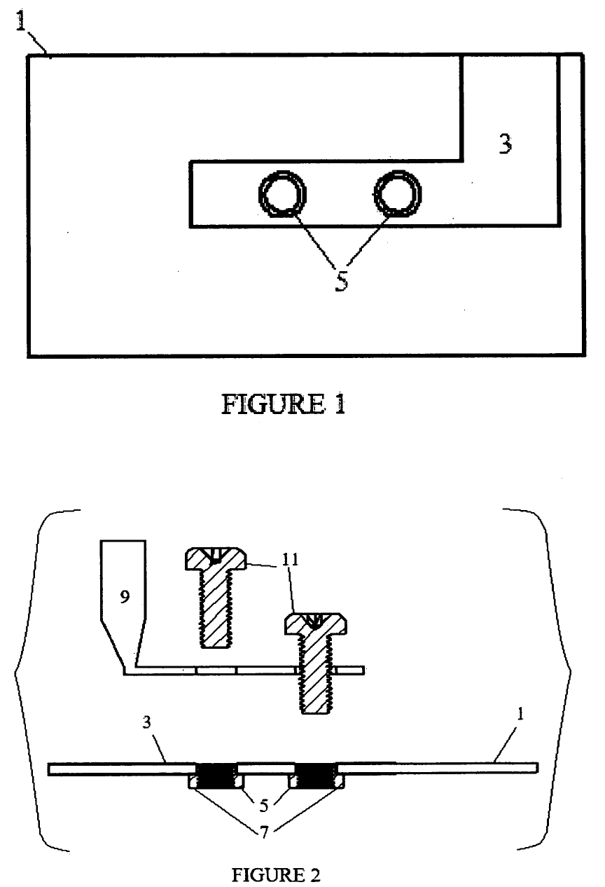

FIG. 1 shows a portion of a PCB 1 having an electrical track 3 which conducts electricity. Captive fasteners 5 have been inserted into the PCB 1 within the conducting area of the electrical track 3. Mating hardware to the captive fasteners 5 are used to secure an electrical connection to the electrical track 3. The simple PCB 1 shown in FIG. 1 is for illustrative purposes. Typically a PCB will contain many tracks and many components other than captive fasteners. It is intended that the captive fasteners 5 of the present invention may provide multiple electrical connections on several tracks on a complex PCB. The physical press fitting of a captive fastener to a PCB 1 is all that is needed to provide the mechanical attachment of the captive fastener to the PCB 1. Further in embodiments of the present invention the press fit connection may be the sole electrical connection with an electrical track 3 in the PCB 1. Captive fasteners 5 often have ridges or barbs around the outside surface which is fit into the substrate. These features add to the strength of the mechanical connection once press fit into a substrate such as a PCB Solder added to the connection between the PCB 1 and captive fastener 5 after press fitting may improve both physical and electrical connections but is not required in embodiments of the present invention. The captive fastener can also be mechanically attached to the PCB 1 with glue, with a threaded connection in the substrate of the PCB, or other suitable mechanical connections.

FIG. 2 shows a cross section of a PCB 1 and captive fastener 5. In the specific embodiment shown in FIG. 2 the captive fastener 5 is a captive nut 7. The captive nut 7 may be made of copper or other conducting material and be a part of the conduction path to an electrical track 3 or may optionally be made of steel or other poorly conducting material and serve only to secure a lead 9 to an exposed portion of an electrical track 3 thus securing an electrical connection between said lead 9 and said track 3. Shown in FIG. 2 are a lead 9 in the form of an angled lug wire termination, and screws 11 which mate with the captive nuts 7. Lock washers (not shown) maybe used in conjunction with bolts 11 to provide a connection that will not loosen with time or vibration. A lead 9 may be a wire with an end lug, a bus bar, a bare wire end, a plug or receptacle termination, or any other sort of conductor or conductor termination suitable to the captive fastener 5 used and to the design requirements of a specific implementation of the present invention. In FIG. 2 there is a pair of captive nuts 7 and screws 11 to secure a single lead 9 preventing rotation of the lead 9. This arrangement is illustrative of one mode of attachment. A single captive fastener 5 per single lead 9 is likely to be the most common implementation of embodiments of the present invention but all combinations of numbers of captive fasteners 5 and leads 9 is conceived and within the scope of the present invention.

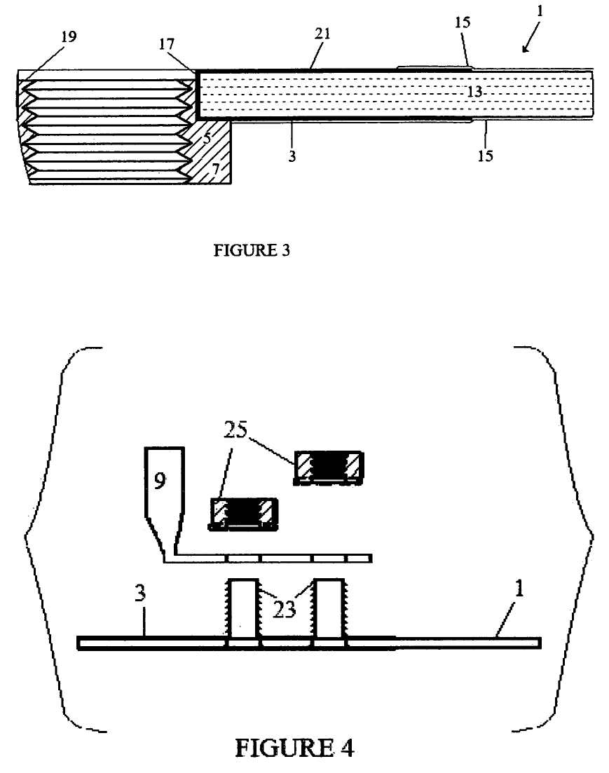

FIG. 3 shows a close up of a single captive nut 7 and an electrical track 3 on a PCB 1. This close up view shows the different components of a PCB 1 which include a core 13, a track 3, and a solder mask 15. The solder mask 15 optionally covers the track 3 except in areas where electrical contact with external components is desired. The track 3 in FIG. 3 is a single conduction path that exists on both sides of the PCB 1. This type of arrangement doubles the current carrying capacity of the track 3 for a given foil thickness. For a double sided track arrangement utilizing the captive fasteners 5 of the present invention the track 3 may be electrically connected between sides via electrically conducting material along the inner rim of a hole 17 through the PCB 1. In the shown embodiment the captive fastener 5 of the present invention is inserted into this same hole 17. The embodiment of the present invention as shown in FIG. 3 may use a captive nut 7 made of a material which is either a poor or a good conductor. The conductance of the captive fastener 5 is of secondary importance in the shown embodiment because a top surface 19 of the captive fastener 5 is lower than the exposed surface 21 of the electrical track 3 thus the captive fastener is primarily causing firm contact between a bottom surface of a lead and the exposed surface 21 of an electrical track 3. If the top surface 19 of the captive fastener 5 were to extend above the exposed surface 21 of the electrical track 3 it would be desirable to construct the captive fastener 5 out of a highly conductive material as the captive fastener 5 would be a part of a conduction path from the lead 9 to the track 3.

FIG. 4 shows a cross section of a PCB 1 and captive fastener 5. In the specific embodiment shown in FIG. 4 the captive fastener 5 is a captive threaded stud 23. The captive threaded stud 23 may be made of copper or other conducting material and be a part of the conduction path to the electrical track 3 in the PCB 1 or may optionally be made of steel or other poorly conducting material and serve only to secure a lead 9 to an exposed portion of an electrical track 3. Also shown in FIG. 4 are a lead 9 in the form of an angled lug wire termination, and nuts 25 which mate with the captive threaded studs 23. Lock washers (not shown) maybe used in conjunction with the nuts 25 to provide a connection that will not loosen with time or vibration.

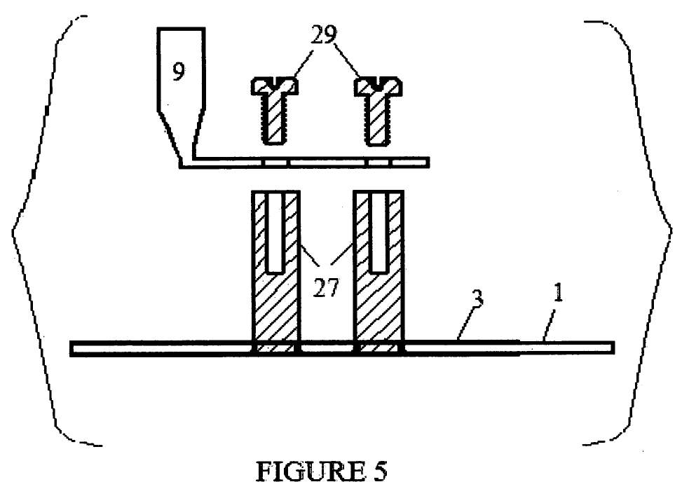

FIG. 5 shows a cross section of a PCB 1 and captive fastener 5. In the specific embodiment shown in FIG. 5 the captive fastener 5 is a captive stand off 27. The captive stand off 27 must be made of copper or other conducting material to be an effective part of a conduction path from a lead 9 to an electrical track 3 in the PCB 1. Since in this embodiment using stand offs 27 a lead 9 is not secured to an exposed portion 21 of an electrical track 3 as in the embodiments shown in FIGS. 2 and 4 it is not advisable to construct the stand offs 27 of steel or other poorly conducting material if significant amounts of power are to be conducted through the captive stand offs 27. Also shown in FIG. 5 are a lead 9 in the form of an angled lug wire termination, and screws 29 which mate with the captive stand off 27. Lock washers (not shown) maybe used in conjunction with the screws 29 to provide a connection that will not loosen with time or vibration.

FIGS. 2, 4, and 5 all show specific embodiments of the present invention using specific captive fasteners 5. The present invention includes many other embodiments spanning the range of captive fastener normally used for mounting a PCB 1 which are instead used to secure an electrical connection. The websites of captive faster manufacturers are good a good source of examples of types of captive fasteners which might be employed in the present invention. The site for PennEngineering® http://www.pemnet.com is a good reference to show many captive fasteners which may be employed as embodiments of the present invention. One variation that may be employed is that the captive fastener may comprise a two-part clip rather than a screw-type connection. The only requirement is that the connection must be made in two halves where one half is captive, or securely attached to the PCB and the second half of the connection fastens to the first half capturing an electrical lead between the two halves. Further the second half may be integral to the electrical lead such that there are only two parts to an electrical connection, a captive faster and an electrical lead formed to mate with the captive fastener. The technique of the present invention is not limited to securing wire terminations. Other items that may be electrically connected using the present invention include a plug, a receptacle, a buss bar, another PCB, and various other electrical terminations which require a secure electrical connection to a PCB.

What is claimed is:

1. A connection that mechanically and electrically connects an electrical lead to a printed circuit board comprising:
a first half of a mechanical connector securely fastened to a substrate of said printed circuit board adjacent to an exposed portion of an electrical conductor that forms part of a circuit on said printed circuit board;
a second half of said mechanical connector that removably attaches to said first half of said mechanical connector;
an electrical lead held captive in between said first half and said second half of said mechanical connector such that said electrical lead is in electrical contact with said exposed portion of said electrical conductor.

2. The connection of claim 1 further comprising a hole in the substrate of said printed circuit board adjacent to said exposed portion of said electrical conductor and wherein said first half of said mechanical connector is securely fastened to the inside of said hole.

3. The connection of claim 2 wherein the diameter of said hole in said substrate is less than the diameter of said first half of said mechanical connector whereby said first half of said mechanical connector is press fit into said hole.

4. The connection of claim 3 wherein said first half of said mechanical connector is a nut and said second half of said mechanical connector is a screw.

5. The connection of claim 3 wherein said first half of said mechanical connector is a stud and said second half of said mechanical connector is a nut.

6. The connection of claim 3 wherein said first half of said mechanical connector is a first half of a clip and said second half of said mechanical connector is a second half of a clip.

7. The connection of claim 6 wherein said second half of a clip is integral to said electrical lead.

8. The connection of claim 2 wherein said first half of said mechanical connector is glued into said hole.

9. The connection of claim 1 wherein said first half of said mechanical connector is fabricated from an electrically conductive material and is in electrical contact with said exposed portion of said electrical conductor.

10. The connection of claim 9 wherein said first half of said mechanical connector is fabricated from copper.

11. The connection of claim 9 further comprising a hole in the substrate of said printed circuit board adjacent to said exposed portion of said electrical conductor and wherein said first half of said mechanical connector is securely fastened to the inside of said hole.

12. The connection of claim 11 wherein the diameter of said hole in said substrate is less than the diameter of said first half of said mechanical connector whereby said first half of said mechanical connector is press fit into said hole.

13. The connection of claim 11 wherein said exposed portion of said electrical conductor extends through the inside of said hole in said substrate and is in electrical contact with said first half of said mechanical connector.

14. The connection of claim 9 wherein said second half of said mechanical connector is fabricated of electrically conducting material.

15. The connection of claim 12 wherein said second half of said mechanical connector is fabricated of electrically conducting material.

16. The connection of claim 13 wherein said second half of said mechanical connector is fabricated of electrically conducting material.

17. The connection of claim 12 wherein said first half of said mechanical connector is a nut and said second half of said mechanical connector is a screw.

18. The connection of claim 12 wherein said first half of said mechanical connector is 10 a stud and said second half of said mechanical connector is a nut.

19. The connection of claim 1 wherein said electrical lead is a bus bar.

20. The connection of claim 1 wherein said electrical lead is a plug.

21. The connection of claim 1 wherein said electrical lead is a-an exposed portion of an electrical circuit on another printed circuit board.

22. The connection of claim 1 wherein said electrical lead is a wire terminated in a lug.

23. The connection of claim 1 wherein said electrical lead is a bare wire.

24. The connection of claim 1 wherein said electrical connection is being made within an Inverter.

25. The connection of claim 3 wherein said electrical connection is being made within an Inverter.

26. The connection of claim 12 wherein said electrical connection is being made within an Inverter.
